(19) United States
(12) Patent Application Publication
(10) Pub. No.: US 2023/0242158 A1
(43) Pub. Date: Aug. 3, 2023

(54) INCORPORATING POSITION ESTIMATION DEGRADATION INTO TRAJECTORY PLANNING FOR AUTONOMOUS VEHICLES IN CERTAIN SITUATIONS

(71) Applicant: Waymo LLC, Mountain View, CA (US)

(72) Inventors: Diomidis Katzourakis, San Jose, CA (US); Bruce Lin, Mountain View, CA (US); Victor Puchkarev, Santa Cruz, CA (US); Carson Schultz, Menlo Park, CA (US); Karankumar Dhankani, Mountain View, CA (US)

(21) Appl. No.: 17/591,130

(22) Filed: Feb. 2, 2022

(51) Int. Cl. B60W 60/00; B60W 30/18

(52) U.S. Cl. CPC B60W 60/0027; B60W 60/0015; B60W 30/181; B60W 2554/80

(57) ABSTRACT

Aspects of the disclosure provide for controlling an autonomous vehicle. For instance, data identifying an object may be received. A first portion of a trajectory may be generated using a first uncertainty distribution for the object. The first portion of the trajectory may enable the autonomous vehicle to make progress towards a destination of the autonomous vehicle. A fallback portion of the trajectory may be generated using a second uncertainty distribution for the object. The fallback portion may enable the autonomous vehicle to stop. The second uncertainty distribution may be different from the first uncertainty distribution, and the second uncertainty distribution may be based on a predetermined uncertainty distribution if the autonomous vehicle loses a localization improvement process. The autonomous vehicle may be controlled according to the trajectory.

### BACKGROUND

Autonomous vehicles for instance, vehicles that may not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, lidar, and other devices that scan, generate and/or record data about the vehicle's surroundings in order to enable the autonomous vehicle to plan trajectories in order to maneuver itself through the surroundings.

### BRIEF SUMMARY

Aspects of the disclosure provide a method of controlling an autonomous vehicle. The method includes receiving, by one or more processors, data identifying an object; generating, by one or more processors, a first portion of a trajectory using a first uncertainty distribution for the object, wherein the first portion of the trajectory enables the autonomous vehicle to make progress towards a destination of the autonomous vehicle; generating, by one or more processors, a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and controlling, by the one or more processors, the autonomous vehicle according to the trajectory.

In one example, the method also includes, determining the first uncertainty distribution as a convolution of a position control error uncertainty distribution and a position perception error uncertainty distribution, and determining the second uncertainty distribution as a convolution of the position control error uncertainty distribution, the position perception error uncertainty distribution, and the predetermined uncertainty distribution. In another example, the method also includes using the second uncertainty distribution to determine a buffer for avoiding the object. In this example, determining the buffer for the object includes using a risk assessment value to identify a value from the second uncertainty distribution. In addition, the risk assessment value indicates how risk-averse the autonomous vehicle should be. In another example, the method also includes planning, by the one or more processors, a second trajectory without using the predetermined uncertainty distribution, and selecting, by the one or more processors, the trajectory from the trajectory and the second trajectory based on a determination of whether the autonomous vehicle is able to use the localization improvement process, and wherein the controlling is in response to the selecting. In another example, generating the first portion includes using a first risk assessment value and generating the fallback portion includes using a second risk assessment value, the first risk assessment value being different from the second risk assessment value.

Another aspect of the disclosure provides a system for controlling an autonomous vehicle. The system includes one or more processors configured to: receive data identifying an object; generate a first portion of a trajectory using a first uncertainty distribution for the object, wherein the first portion of the trajectory enables the autonomous vehicle to make progress towards a destination of the autonomous vehicle; generate a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and control the autonomous vehicle according to the trajectory.

In one example, the one or more processors are further configured to: determine the first uncertainty distribution as a convolution of a position control error uncertainty distribution and a position perception error uncertainty distribution and determine the second uncertainty distribution as a convolution of the position control error uncertainty distribution, the position perception error uncertainty distribution, and the predetermined uncertainty distribution. In another example, the one or more processors are further configured to use the second uncertainty distribution to determine a buffer for avoiding the object. In this example, the one or more processors are further configured to determine the buffer for the object by using a risk assessment value to identify a value from the second uncertainty distribution. In addition, the risk assessment value indicates how risk-averse the autonomous vehicle should be. In another example, the one or more processors are further configured to plan a second trajectory without using the predetermined uncertainty distribution and select the trajectory from the trajectory and the second trajectory based on a determination of whether the autonomous vehicle is able to use the localization improvement process, and wherein the controlling is in response to the selecting. In another example, the one or more processors are further configured to generate the first portion by using a first risk assessment value and generating the fallback portion includes using a second risk assessment value, the first risk assessment value being different from the second risk assessment value. In another example, the system also includes the autonomous vehicle.

A further aspect of the disclosure provides a non-transitory recording medium on which instructions are stored. The instructions, when executed by one or more processors, cause the one or more processors to perform method of controlling an autonomous vehicle. The method includes: receiving data identifying an object; generating a first portion of a trajectory using a first uncertainty distribution for the object, wherein the first portion of the trajectory enables the autonomous vehicle to make progress towards a destination of the autonomous vehicle; generating a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and controlling the autonomous vehicle according to the trajectory.

In one example, the method also includes determining the first uncertainty distribution as a convolution of a position control error uncertainty distribution and a position perception error uncertainty distribution and determining the second uncertainty distribution as a convolution of the position control error uncertainty distribution, the position perception error uncertainty distribution, and the predetermined uncertainty distribution. In another example, the method also includes using the second uncertainty distribution to determine a buffer for avoiding the object. In this example, the method includes determining the buffer for the object further by using a risk assessment value to identify a value from the second uncertainty distribution. In another example, the method also includes planning a second trajectory without using the predetermined uncertainty distribution and selecting the trajectory from the trajectory and the second trajectory based on a determination of whether the autonomous vehicle is able to use the localization improvement process, and wherein the controlling is in response to the selecting.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6A is an example of a geographic area, an autonomous vehicle and other objects in accordance with aspects of the disclosure.

FIG. 6B is an example of map information, an autonomous vehicle, and detected objects in accordance with aspects of the disclosure.

FIG. 7 is an example of map information, an autonomous vehicle, a detected object, and a behavior prediction in accordance with aspects of the disclosure.

FIG. 8 is an example of map information, an autonomous vehicle, a detected object, and a behavior prediction in accordance with aspects of the disclosure.

FIG. 9 is an example of map information, an autonomous vehicle, detected objects, and distances to those objects in accordance with aspects of the disclosure.

FIG. 10 is an example representation of a convolution of a plurality of uncertainty distributions into an overall uncertainty distribution in accordance with aspects of the disclosure.

FIG. 11 is an example representation of an overall uncertainty distribution and using a risk assessment value to determine an uncertainty value in accordance with aspects of the disclosure.

FIG. 12 is an example representation of map information, an autonomous vehicle, detected objects, and buffer areas in accordance with aspects of the disclosure.

FIG. 13 is an example representation of map information, an autonomous vehicle, detected objects, buffer areas, and a first portion of a trajectory in accordance with aspects of the disclosure.

FIG. 14 is an example representation of a convolution of a plurality of uncertainty distributions into an overall uncertainty distribution in accordance with aspects of the disclosure.

FIG. 15 is an example representation of an overall uncertainty distribution and using a risk assessment value to determine an uncertainty value in accordance with aspects of the disclosure.

FIG. 16 is an example representation of map information, an autonomous vehicle, detected objects, and buffer areas in accordance with aspects of the disclosure.

FIG. 17 is an example representation of map information, an autonomous vehicle, detected objects, buffer areas, and a trajectory in accordance with aspects of the disclosure.

FIG. 18 is a flow diagram in accordance with aspects of the disclosure.

### DETAILED DESCRIPTION

### Overview

The technology relates to incorporating degradation of position control into trajectory planning for autonomous vehicles. Knowing an autonomous vehicle's exact location is critical to safely maneuvering through the autonomous vehicle's environment. For instance, errors in the autonomous vehicle's position (e.g. location and orientation/heading) estimation can result in unwanted deviation from the intended path of the autonomous vehicle. In rare cases, this can be extreme if the autonomous vehicle's localization improvement processes which improve position estimation using spatial knowledge (e.g. information relative to pre-stored map information), rather than pure inertial and odometry information, are lost. An example of a localization improvement process would be the iterative closest point differencing algorithm that uses lidar returns to improve position accuracy. Of course, the autonomous vehicle's systems may use other and additional types of localization improvement processes.

A planning system of an autonomous vehicle may generate a trajectory and send it to another computing system in order to control the vehicle according to that trajectory. The trajectory may include a first portion that allows the vehicle to proceed towards its end goal or destination, and thereafter, the trajectory may include a fallback portion. This fallback portion may include instructions for the vehicle to safely pull over, stop, etc. such that if a new trajectory is not received in time, the vehicle can safely pull over.

In situations in which these fallback portions are actually used and the aforementioned localization improvement processes are no longer functioning, the autonomous vehicle may inadvertently drift from its desired trajectory during this fallback portion. In some situations, this drift may potentially result in coming too close to other road user objects (e.g. other vehicles, bicyclists, pedestrians, etc.) or potentially colliding, for instance, when the autonomous vehicle accumulates more position error than it has budgeted for when planning trajectories.

For instance, some trajectory planning approaches may involve using various uncertainty models in order to ensure appropriate buffer distances or gaps around other road user objects current and predicted future locations are maintained. For instance, these other road users may be detected by a perception system of the autonomous vehicle, and their predicted future locations may be estimated by a behavior modeling system of the autonomous vehicle.

These approaches may account for uncertainty in position errors, such as those resulting from both the autonomous vehicle's position control error (e.g. how close the autonomous vehicle's actual position is to a desired position according to the autonomous vehicle's current planned trajectory) and position perception error (e.g. how close a detected object is to the autonomous vehicle). This information may be tracked in real time across a plurality of autonomous vehicles and used offline, for instance by one or more server computing devices to generate control error uncertainty distributions and perception uncertainty distributions.

While planning the first portion of a trajectory, the planning system may utilize a first uncertainty distribution and a second uncertainty distribution for each detected object, including, for instance, other road users as well as other detected objects such as vegetation, trash, parking cones, road signs, etc. For instance, the planning system may select the first uncertainty distribution from the position control error uncertainty distributions. To do so, the planning system may estimate where along the autonomous vehicle is likely to come closest to the detected object. For some objects, this may involve determining the closest point of interaction between the object and the autonomous vehicle on the first portion of the trajectory, then backtracking to estimate the speed and lateral acceleration of the autonomous vehicle at that point. For other objects, this may involve estimating a speed profile for the first portion of the trajectory and determining a speed profile for the object and using these speed profiles to estimate at the first (in time) closest point of interaction between the object and the autonomous vehicle on the first portion of the trajectory. In other instances, for example, for objects that are far away from the autonomous vehicle or those objects that are moving at the same or a similar speed as the autonomous vehicle, this first interaction point may become arbitrary and quite far away.

In addition, the planning system may select one or more second uncertainty distributions from the perception uncertainty distributions. For instance, for each detected object, the uncertainty in the distance to that object may be dependent upon the distance to that object at the time the object was detected by the perception system. As such, the planning system may select the perception uncertainty distribution for an object based on that distance.

For each object, the first distribution and second distribution may be combined into a single distribution. This may involve a typical convolution process. The resulting overall uncertainty distribution (“first overall uncertainty distribution”) may therefore represent the likelihood of the autonomous vehicle coming closer to that object than expected or intended.

The planning system may then access a risk assessment value which indicates how risk-averse the autonomous vehicle should be. For instance, this risk assessment value may be a limit on a number of a certain type of interactions such as collisions or near collisions for some amount of driving. These values may be set or allocated based on safety and other concerns of an autonomous vehicle service, etc.

The risk assessment value may then be used to query the first overall uncertainty distribution to find a value or range of values. These values may then be used to define a buffer around an object which the autonomous vehicle should avoid when planning the first portion of a trajectory. In some instances, the buffer may be determined by adding the value to a minimum buffer value. The buffer may then be used as a constraint to limit how close the autonomous vehicle can come to the object and its predicted future locations when planning the first portion of the trajectory. As a result, the likelihood of having a near collision or collision will be smaller than the risk assessment value for the interaction.

To further reduce the likelihood of situations like coming too close or colliding with another road user object when following a fallback portion of a trajectory, additional uncertainties may be taken into account. For instance, the fallback portion of the trajectory may be planned to take into account uncertainty caused by loss of functionality of the localization improvement processes. In this regard, the planning system may generate the fallback portion of a trajectory according to this “worst-case-scenario”. In this regard, a third uncertainty distribution, which characterizes the different likelihoods of potential position error in the event that the localization improvement processes are lost, may be used.

Thus, during planning of the fallback portion, the planning system may not only select first and second distributions for each object as described above, but these may be convolved with the third uncertainty distribution. This may again involve a typical convolution process as described above. The resulting second overall uncertainty distribution may therefore represent the likelihood of the autonomous vehicle coming closer to that object than expected or intended if there is a total loss of functionality into the localization improvement processes.

As with the planning of the first portion of the trajectory, the same or a different risk assessment value (e.g. one specifically designated for fallback situations) may then be used to query the second overall uncertainty distribution to find a value or range of values. These values may then be used to define a buffer around an object which the autonomous vehicle should avoid when planning the fallback portion of the trajectory. As a result, the likelihood of having a near collision or collision will be smaller than the risk assessment value for the interaction. For instance, because localization error will accumulate with time and distance traveled, the buffer distances for objects that are farther away from the autonomous vehicle will be greater than the buffer distances for objects (of the same time) that are closer to the vehicle.

The computing devices of the vehicle may then use this trajectory to control the autonomous vehicle. Under normal operation, because the trajectory used by the computing devices is updated before the autonomous vehicle reaches the fallback portion, the autonomous vehicle only follows the nominal trajectory. However, if a new trajectory is not published by the time the fallback portion is reached or some point before this, the computing devices may simply continue to follow the fallback portion of the fallback trajectory and bring the autonomous vehicle to a stop.

The features described herein may allow autonomous vehicles to incorporate degradation of localization improvement processes into trajectory planning for autonomous vehicles. By doing so, the autonomous vehicle may be able to operate longer under degraded conditions. This, in turn, may make it more likely that the autonomous vehicle will reach a safe stopping position (e.g. out of traffic or away from other dangers) when following a fallback portion of a trajectory.

### Example Systems

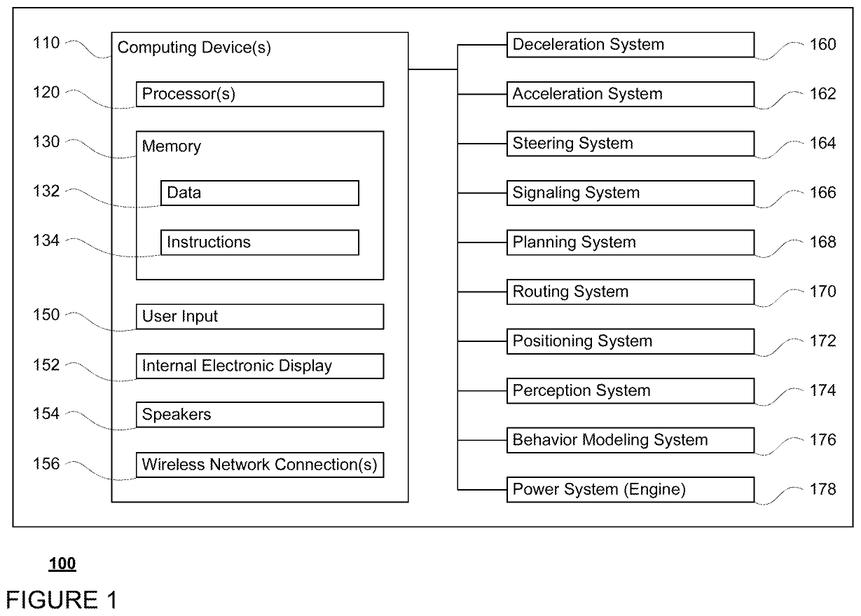

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the vehicle assists with one or more driving operations (e.g., steering, braking and/or accelerating to perform lane centering, adaptive cruise control or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

In contrast, in a fully autonomous driving mode, the control system of the vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the vehicle may be any type of vehicle including, but not limited to, cars, trucks (e.g. garbage trucks, tractor-trailers, pickup trucks, etc.), motorcycles, buses, recreational vehicles, street cleaning or sweeping vehicles, etc. The vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the vehicle in order to control the vehicle in an autonomous driving mode. For example, returning to FIG. 1, computing devices 110 may be in communication with various systems of autonomous vehicle 100, such as deceleration system 160, acceleration system 162, steering system 164, signaling system 166, forward planning system 168, routing system 170, positioning system 172, perception system 174, behavior modeling system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the vehicle. Computing devices 110 may also use the signaling system 166 in order to signal the vehicle's intent to other drivers or vehicles, for example, by lighting turn signals or brake lights when needed.

Routing system 170 may be used by computing devices 110 in order to generate a route to a destination using map information. Planning system 168 may be used by computing device 110 in order to generate short-term trajectories that allow the vehicle to follow routes generated by the routing system. In this regard, the forward planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

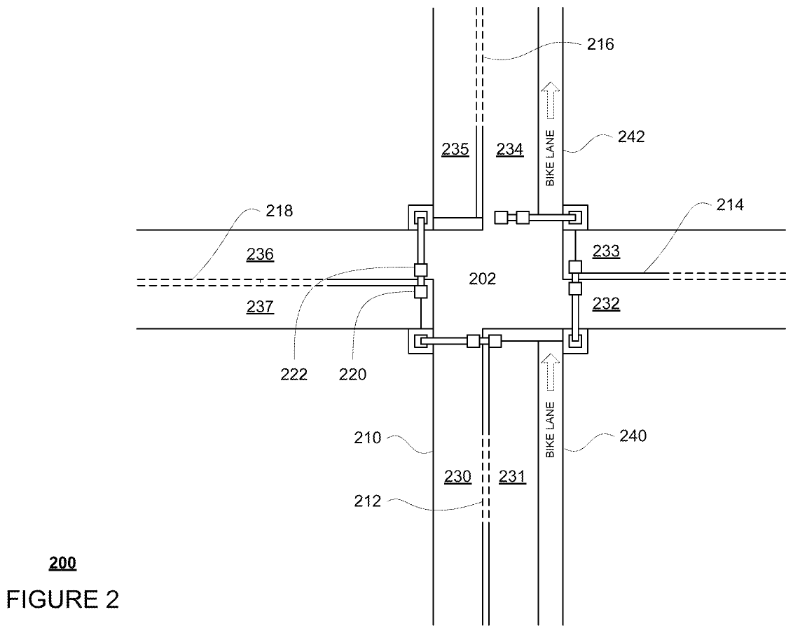

FIG. 2 is an example of map information 200 for a section of roadway including intersection 202. The map information 200 may be a local version of the map information stored in the memory 130 of the computing devices 110. In this example, the map information 200 includes information identifying the shape, location, and other characteristics of lane lines 210, 212, 214, 216, 218 which define the shape and location of lanes 230, 231, 232, 233, 234, 235, 236, 237. In addition, the map information may include additional details such as the characteristics (e.g. shape, location, configuration etc.) of traffic controls including traffic signal lights (such as traffic signal lights 220, 222), signs (such as stop signs, yield signs, speed limit signs, road signs, and so on), bicycle lanes (such as bicycle lanes 240, 242) crosswalks, sidewalks, curbs, buildings or other monuments, etc.

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the autonomous vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which lanes are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the vehicle, etc. Each route may include a list of a plurality of nodes and edges which the vehicle can use to reach the destination. Routes may be recomputed periodically as the vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of a the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the vehicle is a passenger vehicle such as a minivan or car, the vehicle may include Lidar, cameras, and/or other sensors mounted on or near the roof, fenders, bumpers or other convenient locations.

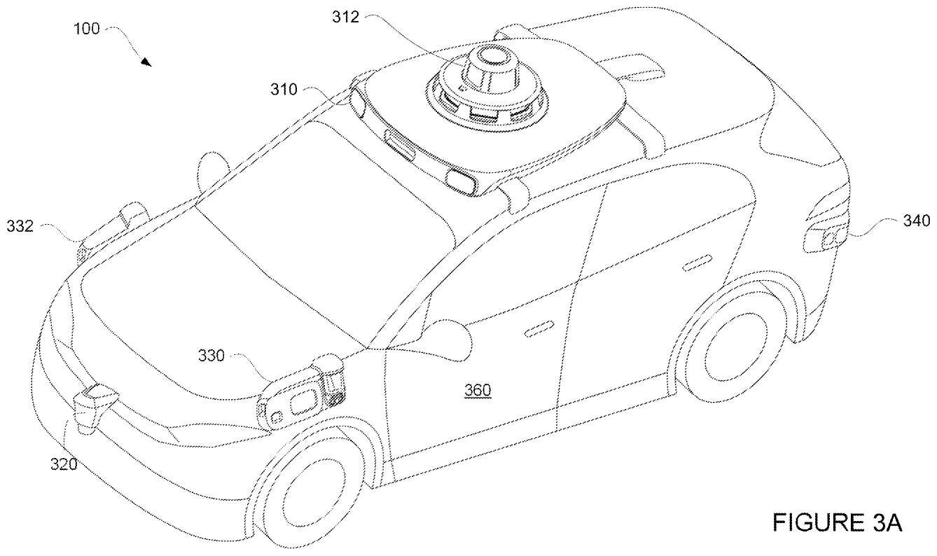

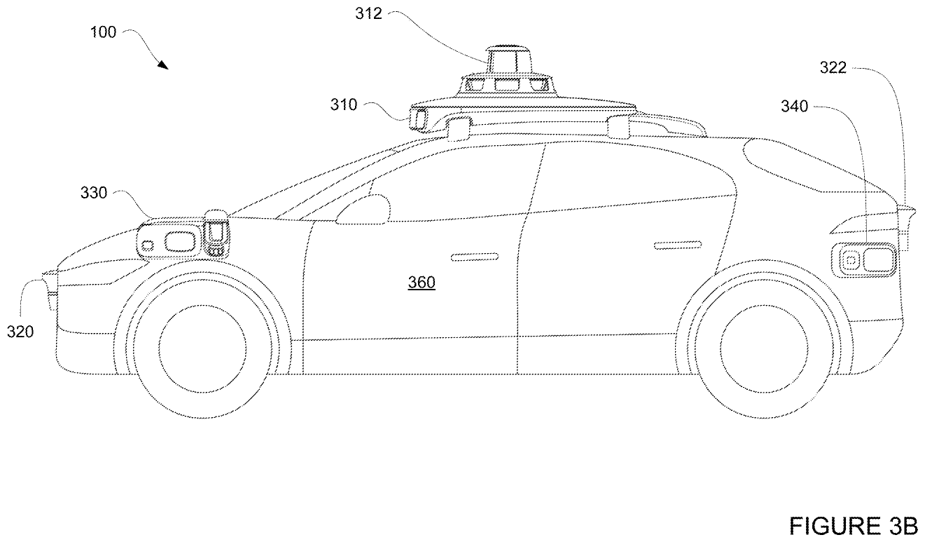

For instance, FIGS. 3A-3B are an example external views of autonomous vehicle 100. In this example, roof-top housing 310 and upper housing 312 may include a Lidar sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also arranged at the corresponding location on the passenger's side of the autonomous vehicle 100. Additional radar units and cameras (not shown) may be located at the front and rear ends of autonomous vehicle 100 and/or on other positions along the roof or roof-top housing 310.

Computing devices 110 may be capable of communicating with various components of the vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, forward planning system 168, routing system 170, positioning system 172, perception system 174, behavior modeling system 176, and power system 178 (i.e. the vehicle's engine or motor) in order to control the movement, speed, etc. of autonomous vehicle 100 in accordance with the instructions 134 of memory 130.

The various systems of the vehicle may function using autonomous vehicle control software in order to determine how to control the vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior modeling system 176 which uses various behavior models based on object type to output one or more behavior predictions or predicted trajectories for a detected object to follow into the future (e.g. future behavior predictions or predicted future trajectories). In this regard, different models may be used for different types of objects, such as pedestrians, bicyclists, vehicles, etc. The behavior predictions or predicted trajectories may be a list of positions and orientations or headings (e.g. poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may use various models to output a likelihood of a construction zone or an object being an emergency vehicle.

Detected objects, predicted trajectories, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate planned trajectories for the vehicle to follow for some brief period of time into the future based on a route generated by a routing module of the routing system 170. Each planned trajectory may provide a planned path and other instructions for an autonomous vehicle to follow for some brief period of time into the future. As noted above, each trajectory may be planned for some period of time into the future such as 10 seconds, 15 seconds, 16 seconds or more or less or at least 70 meters using a planning interval of 0.125 seconds or more or less for a speed component or 0.5 meter or more or less for a geometry component. In some instances, these may be fixed values or may be adjusted in real time based on a number of factors such as current speed of the autonomous vehicle, speed limit of the road on which the autonomous vehicle is currently traveling, etc.

Each trajectory may include a first portion that allows the vehicle to proceed towards its end goal or destination, and thereafter, the trajectory may include a second, fallback portion. This fallback portion may include instructions for the vehicle to safely pull over, stop, etc. such that if a new trajectory is not received in time (i.e. before the autonomous vehicle reaches the fallback portion of a trajectory or some point before this), the vehicle can safely pull over. In this regard, the trajectories may define the specific characteristics of acceleration, deceleration, speed, direction, etc. to allow the vehicle to follow the route towards reaching a destination as well as to follow the fallback portion if a new trajectory is not received in time. A control system software module of computing devices 110 may be configured to control movement of the vehicle, for instance by controlling braking, acceleration and steering of the vehicle, in order to follow a trajectory.

In some instances, the planning system 168 may plan two trajectories. For instance, the planning system 168 may plan a nominal trajectory or a long term (e.g. 10, 12, 16 second or more or less) plan to maneuver the vehicle towards its destination. However, rather than publishing this trajectory, the planning system 168 may also generate a second or fallback trajectory. When planning a fallback trajectory, the planning system 168 may extract or matches an initial section of the nominal trajectory, such as 400 milliseconds or more or less, and uses this as the first portion of the fallback trajectory. The fallback portion of the fallback trajectory may then be determined independently from the nominal trajectory. The fallback trajectory may then be published to other systems of the autonomous vehicle and used to control the autonomous vehicle. In this regard, the computing devices 110 are always executing a fallback trajectory, though under normal operation do not execute the entire fallback trajectory. Under normal operation, because the trajectory used by the computing devices 110 is updated before the autonomous vehicle reaches the fallback portion (e.g. the 400 milliseconds section where the fallback trajectory diverges from the nominal trajectory), the autonomous vehicle only follows the nominal trajectory. However, if a new trajectory is not published by the time the fallback portion is reached or some point before this, the computing devices 110 may simply continue to follow the fallback portion of the fallback trajectory and bring the autonomous vehicle to a stop.

In this regard, the computing devices 110 may control the vehicle in one or more of the autonomous driving modes by controlling various components. For instance, by way of example, computing devices 110 may navigate the vehicle to a destination location completely autonomously using data from the detailed map information and forward planning system 168. Computing devices 110 may use the positioning system 170 to determine the vehicle's location and perception system 174 to detect and respond to objects when needed to reach the location safely. Again, in order to do so, computing device 110 and/or forward planning system 168 may generate trajectories as described above and below and may cause the vehicle to follow these trajectories, for instance, by causing the vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

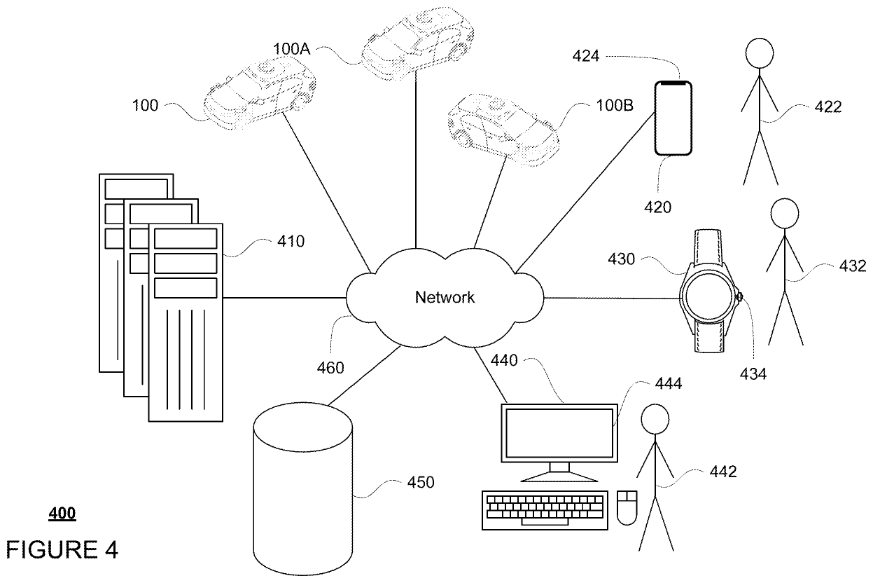

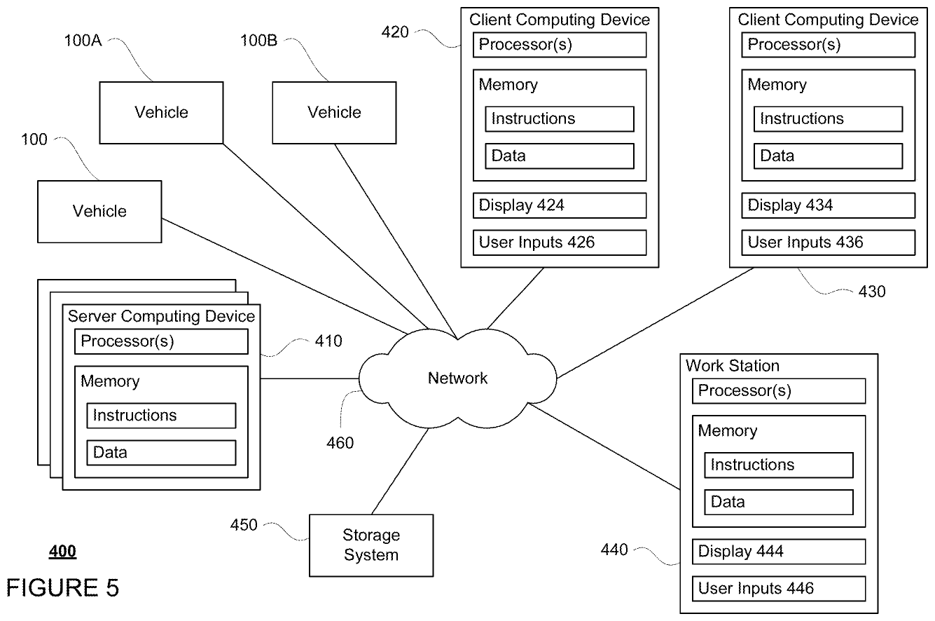

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes autonomous vehicle 100A and autonomous vehicle 100B, which may be configured the same as or similarly to autonomous vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A or autonomous vehicle 100B as well as computing devices 420, 430, 440 via the network 460. For example, autonomous vehicles 100, 100A, 100B, may be a part of a fleet of vehicles that can be dispatched by server computing devices to various locations. In this regard, the server computing devices 410 may function as a scheduling system which can be used to arrange trips for passengers by assigning and dispatching vehicles such as autonomous vehicles 100, 100A, 100B. These assignments may include scheduling trips to different locations in order to pick up and drop off those passengers. In this regard, the server computing devices 410 may operate using scheduling system software in order to manage the aforementioned autonomous vehicle scheduling and dispatching as well as other functions. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 3, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example the user may input information using a small keyboard, a keypad, microphone, using visual signals with a camera, or a touch screen. As yet another example, client computing device 440 may be a desktop computing system including a keyboard, mouse, camera and other input devices.

In some examples, client computing device 420 may be a mobile phone used by a passenger of a vehicle. In other words, user 422 may represent a passenger. In addition, client computing device 430 may represent a smart watch for a passenger of a vehicle. In other words, user 432 may represent a passenger. The client computing device 440 may represent a workstation for an operations person, for example, a remote assistance operator or someone who may provide remote assistance to a vehicle and/or a passenger. In other words, user 442 may represent an operator (e.g. operations person) of a transportation service utilizing the autonomous vehicles 100, 100A, 100B. Although only a few passengers and operations persons are shown in FIGS. 4 and 5, any number of such passengers and remote assistance operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, etc. Storage system 450 may store various types of information which may be retrieved or otherwise accessed by a server computing device, such as one or more server computing devices 410, in order to perform some of the features described herein.

As noted above, some trajectory planning approaches, which may be used by the planning system 168, may involve using various uncertainty models in order to ensure appropriate buffer distances or gaps around other road user objects current and predicted future locations are maintained. As noted above, these approaches may also account for uncertainty in both the autonomous vehicle's position control error and position perception error.

This information may be tracked in real time across a plurality of autonomous vehicles, such as autonomous vehicles 100, 100A, and 100B and used offline, for instance by the server computing devices 410 in to generate position control error uncertainty distributions and perception uncertainty distributions. For instance, the tracked information may be sent to the server computing devices 410 by the autonomous vehicles 100, 100A, 100B via the network 460 periodically or may be uploaded directly to the server computing devices via a wired or wireless link periodically. The server computing devices 410 may process the tracked information in order to generate models or distributions (“uncertainty distributions”). For instance, the server computing devices 410 may generate position control error distributions and perception uncertainty distributions. These distributions may then be sent to the autonomous vehicles, via the network 460 or may be downloaded directly from the server computing devices via a wired or wireless link periodically, in order to enable the autonomous vehicles to store (for instance in the memory 130 or other memory of the autonomous vehicle), access, and use these distributions as needed.

In some instances, the position control error uncertainty distributions may be sliced by speed of the autonomous vehicle and lateral acceleration as well as type of object, and the perception uncertainty distributions may be sliced by distance to a detected object (when it is detected) as well as type of object. Further slicing may be achieved for other situations, such as weather conditions, etc. In this regard, for each type of object, the autonomous vehicle may store a plurality of position control error uncertainty distributions for different speeds and lateral accelerations. Similarly, for each type of object, the autonomous vehicle may store a plurality of perception system uncertainty distributions for different distances.

The perception uncertainty distributions may be spliced by distance as objects farther from the autonomous vehicle may have different uncertainty distributions than those that are closer. For example when objects are very close to an autonomous vehicle, noise generated by the sensors of the autonomous vehicle's perception system may be dominated by false returns (e.g. returns for spurious objects such as dust, mist, etc.). As such, an object's perceived size may tend to be larger than reality. In some instances, the error can be quite large. For objects that are farther away, the sensors may not be quite as sensitive to this noise so some of the error may go down. However, at the same time other noise may start to have a greater influence on uncertainty. This other noise may include, for example, lack of return on some real surfaces, resolution of scans missing some features, or causing segmentation to group some objects together. In this regard, perception system uncertainty distributions may differ depending on the distance between the object and the autonomous vehicle when the object is perceived by the sensors of the perception system.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

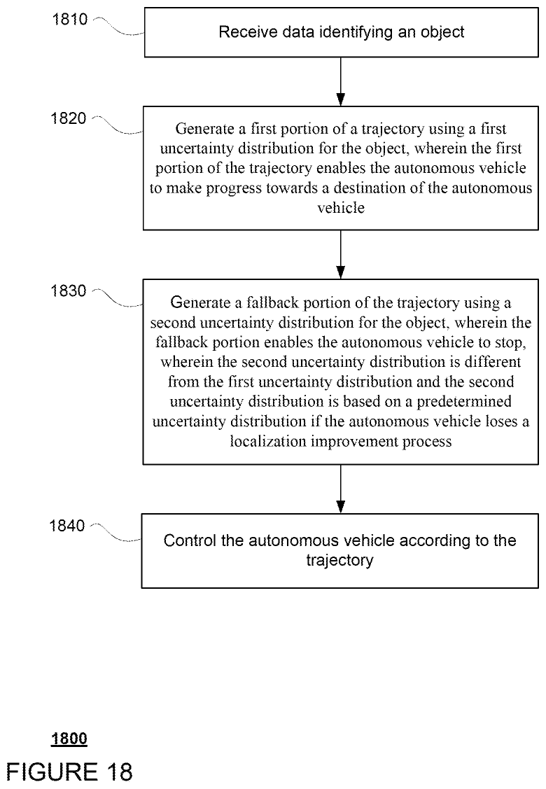

FIG. 18 is an example flow diagram 1800 for a method of controlling an autonomous vehicle which may be performed by one or more processors of an autonomous vehicle, such as processors 120, processors of the perception system, or other processors of the autonomous vehicle. In this example, at block 1810, data identifying an object is received. For instance, the perception system 174 may detect and identify objects in the autonomous vehicle's environment. At least some of these objects may include road users, but other object may include lane lines, curbs, traffic signal lights, and other features.

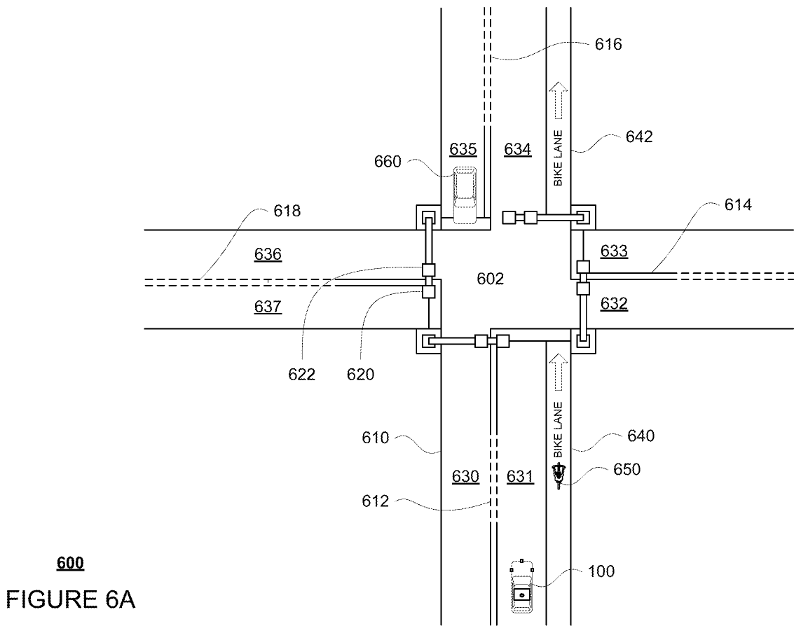

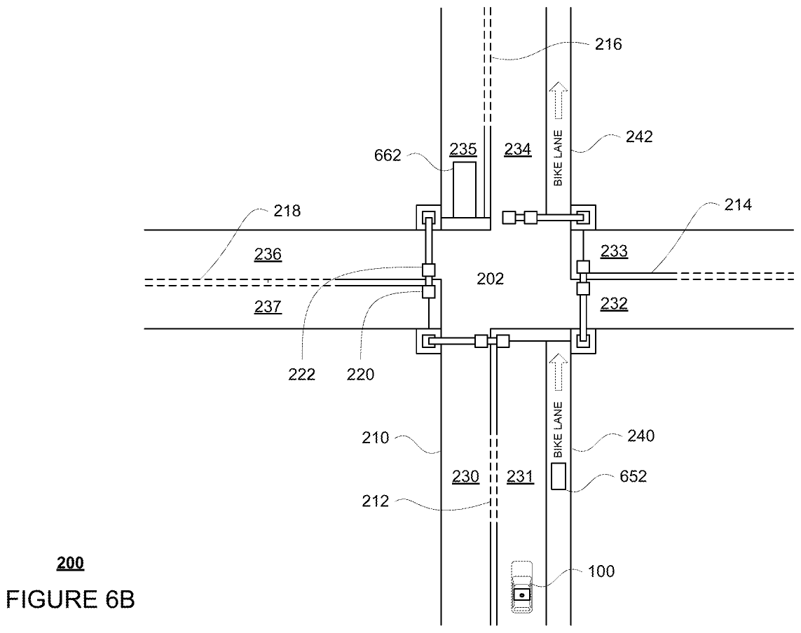

For example, FIG. 6A depicts the autonomous vehicle 100 in a geographic area 600 corresponding to the map information 200. In this example, intersection 602 corresponds to intersection 202, lane lines 610, 612, 614, 616, 618 correspond to lane lines 210, 212, 214, 216, 218, lanes 630, 631, 632, 633, 634, 635, 636, 637 correspond to lanes 230, 231, 232, 233, 234, 235, 236, 237, traffic signal lights 620, 622 correspond to traffic signal lights 220, 222, bicycle lanes 640, 642 correspond to bicycle lanes 240, 242, and so on. In this example, the autonomous vehicle 100 is driving in lane 631. Other road users, including a bicyclist 650 and a vehicle 660, are traveling in bicycle lane 640 and lane 635, respectively.

The perception system 174 may detect and identify the bicyclist 650 and vehicle 660 as well as other features of the autonomous vehicle's environment. For instance, FIG. 6B includes the map information 200 as well as data for the bicyclist 650 and vehicle 660 generated by the perception system 174. This data is represented by bounding boxes 652 and 662, respectively. In addition, the autonomous vehicle is following a route 670 generated by the routing system 170 as described above. The route 670 includes the autonomous vehicle traveling through intersection 202 (also 602) and into lane 234 (also lane 634) to a destination (not shown). The data generated by the perception system may be published to other systems of the autonomous vehicle, for instance including the behavior modeling system 176 (in order to generate behavior predictions for detected objects) and planning system 168.

Returning to FIG. 18, at block 1820, a first portion of a trajectory is generated using a first uncertainty distribution for the object. The first portion of the trajectory enables the autonomous vehicle to make progress towards a destination of the autonomous vehicle. While planning the first portion of a trajectory or the nominal trajectory from which the first portion is extracted as described above, the planning system may utilize a first uncertainty distribution and a second uncertainty distribution for each detected object, including, for instance other road users as well as other detected objects such as vegetation, trash, parking cones, road signs, etc. For instance, the planning system may select the first uncertainty distribution from the position control error uncertainty distributions. To do so, the planning system may estimate where along the autonomous vehicle is likely to come closest to the detected object.

For some objects, this may involve determining the closest point of interaction (“interaction point”) between the object and the autonomous vehicle on the trajectory , then backtracking to estimate the speed and lateral acceleration of the autonomous vehicle at that point. The trajectory used may be the nominal trajectory that is being planned currently. In this regard, the planning system may take a first pass at calculating a trajectory and use that to find the interaction point. The trajectory may then be based on the uncertainty models in an iterative process. As described below, one approach for the first pass for determining the new trajectory is to use the previous trajectory. The planning system 168 may find the interaction point and then use the curvature of the trajectory at the interaction point (curvature is purely geometric) to estimate the speed and lateral acceleration interaction at the interaction point. The lateral acceleration may be estimated based on the speed of the autonomous vehicle and the curvature of the trajectory at the interaction point.

One simple approach for estimating the speed is to take the autonomous vehicle's speed at some short time in the future (e.g. 300 milliseconds or more or less) from the prior trajectory. This is not necessarily a conservative approach, but as the autonomous vehicle gets closer to the object, this approach has a property that it may tend towards the speed at which the autonomous vehicle will be interacting with the object.

Another more conservative approach may be to use the maximum speed that the autonomous vehicle could accelerate to by the interaction point. This maximum speed may be limited by the speed limit of the road on which the autonomous vehicle is currently traveling, acceleration and jerk limits for the autonomous vehicle, as well as the distance to the object. So for an object that is very far away this maximum speed may tend to be the road speed limit, while for an object very close to the autonomous vehicle, this may be very similar to the above-described simple approach. However, for this approach, if the planning system can't increase a bugger to the object to satisfy the requirement at that speed, but could if we planned to drive a bit slower, then the planning system may use the slower speed while also adding a constraint to solving for the autonomous vehicle's speed along the trajectory to limit the autonomous vehicle's maximum speed at the interaction point.

For some objects that are moving, this may involve estimating a speed profile for the first portion of the trajectory and determining a speed profile for the object and using these speed profiles to estimate at the first (in time) closest point of interaction between the object and the autonomous vehicle in spacetime, rather than on the trajectory, as the interaction point. This can be estimated by considering the speed of the object along the autonomous vehicle's trajectory as well as an estimate of the autonomous vehicle's speed at that interaction point (e.g. estimated as described above). This then can be mapped to a problem along the autonomous vehicle's trajectory where the planning system has some estimate for our speed profile as well as some estimate for the speed profile for the other object and is attempting to find a place where these two profiles will come to a common point.

In some instances, for example, for objects that are far away from the autonomous vehicle or those objects that are moving at the same or a similar speed as the autonomous vehicle, this first interaction point may become arbitrary and quite far away. In such instances, the planning system 168 may use the closest point on the trajectory to the object's current position. In reality this does not matter too much since what it says approximately is that the autonomous vehicle will not really interact with the object, because the autonomous vehicle is driving behind the object and falling behind such that the longitudinal gap is getting larger or staying the same or the object is driving behind the autonomous vehicle and falling behind such that the longitudinal gap is getting larger or staying the same.

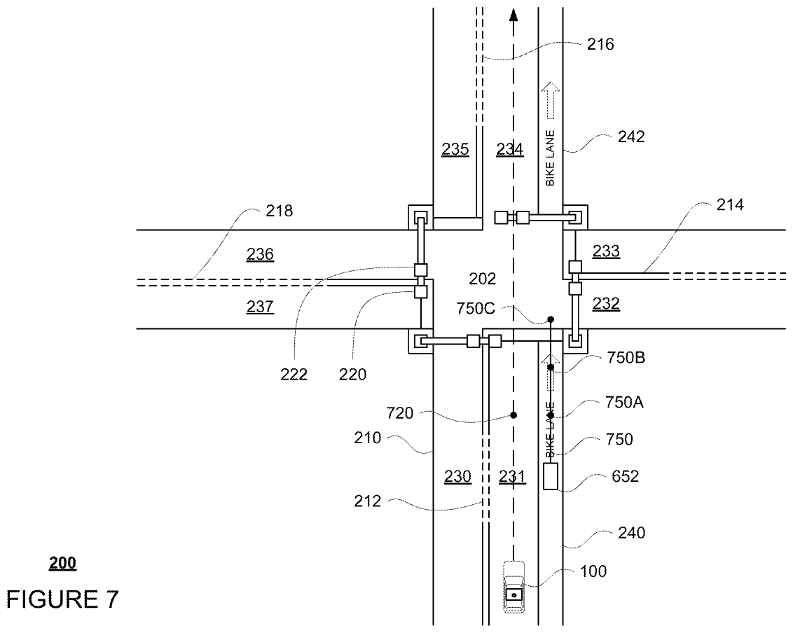

Turning to FIG. 7, the behavior modeling system 170 may generate a behavior prediction 750 for the bicyclist 650. The behavior prediction 750 may include a plurality of locations (here locations 750A, 750B, 750C), orientations, headings, speeds, accelerations, etc. at different points in the future. For simplicity only three locations are depicted, although a behavior prediction may include dozens, hundreds or even thousands of predicted locations. In this example, the behavior prediction and a trajectory 710 may indicate that the interaction point for the bicyclist is when the autonomous vehicle is at location 720 and the bicyclist is at location 750B (i.e. when the autonomous vehicle is predicted to pass the bicyclist 650). The planning system 168 may then estimate a lateral acceleration and speed for the autonomous vehicle at location 720. The estimated lateral acceleration and speed may then be used to select a first uncertainty distribution for the bicyclist 650 or a position control error uncertainty distribution for the bicyclist 650 from the plurality of position control error uncertainty distributions for bicyclists.

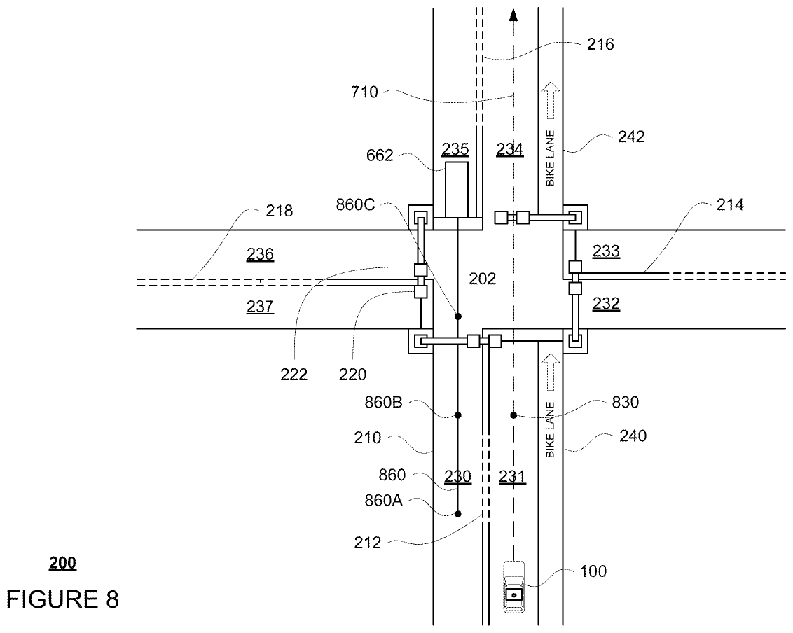

Turning to FIG. 8, the behavior modeling system 176 may generate a behavior prediction 860 for the vehicle 660. The behavior prediction 860 may include a plurality of locations (here locations 860A, 860B, 860C), orientations, headings, speeds, accelerations, etc. at different points in the future. Again, for simplicity only three locations are depicted although a behavior prediction may include dozens, hundreds or even thousands of predicted locations. In this example, the behavior prediction and the trajectory 710 may indicate that the interaction point for the bicyclist is when the autonomous vehicle is at location 830 and the vehicle is at location 860C (i.e. when the autonomous vehicle is predicted to pass the vehicle 660). The planning system 168 may then estimate a lateral acceleration and speed for the autonomous vehicle at location 830. The estimated lateral acceleration and speed may then be used to select a first uncertainty distribution for the vehicle 660 or a position control error uncertainty distribution for the vehicle 660 from the plurality of position control error uncertainty distributions for vehicles.

In addition, the planning system 168 may select one or more second uncertainty distributions from the perception uncertainty distributions. For instance, for each detected object, the uncertainty in the distance to that object may be dependent upon the distance to that object at the time the object was (last) detected by the perception system. As such, the planning system may select one of the plurality of perception uncertainty distributions for an object based on that distance.

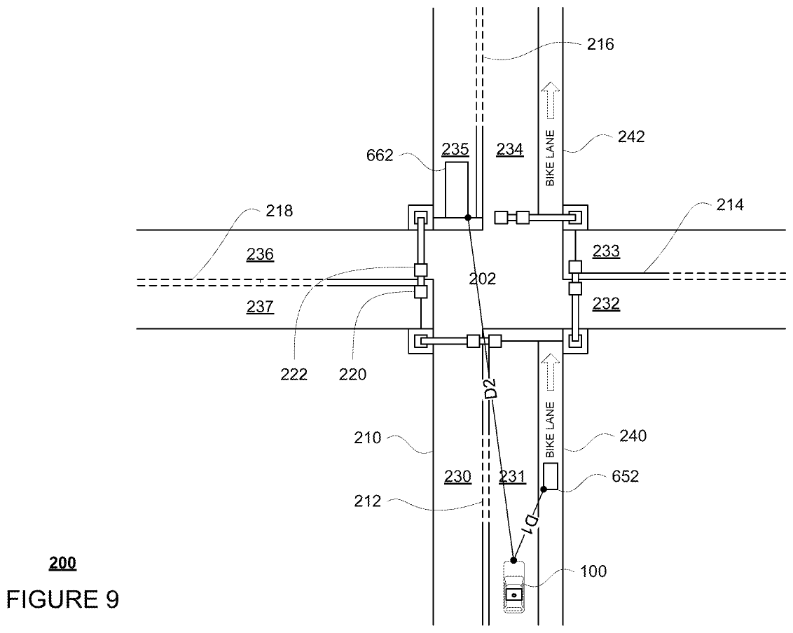

For instance, FIG. 9 represents the locations of the bicyclist 650, represented by bounding box 652 and the vehicle 660 represented by bounding box 662 at the time the data generated by the perception system was generated. In this example, the distance to the bounding box 652 is D1 and the distance to the bounding box 662 is D2. The value of D1 may be used to select a perception uncertainty distribution from the plurality of prestored perception system uncertainty distributions for bicyclists. The value of D2 may be used to select a perception uncertainty distribution from the plurality of prestored perception system uncertainty distributions for vehicles.

For each object, the first distribution and second distribution may be combined into a single distribution. This may involve a typical convolution process. The resulting overall uncertainty distribution (“first overall uncertainty distribution”) may therefore represent the likelihood of the autonomous vehicle coming closer to that object that expected or intended. Because actual convolution can be computationally expensive, the planning system 168 may alternatively use an approximation by utilizing an assumption that the distributions to be convolved are “bell shaped” which may make the computation much faster.

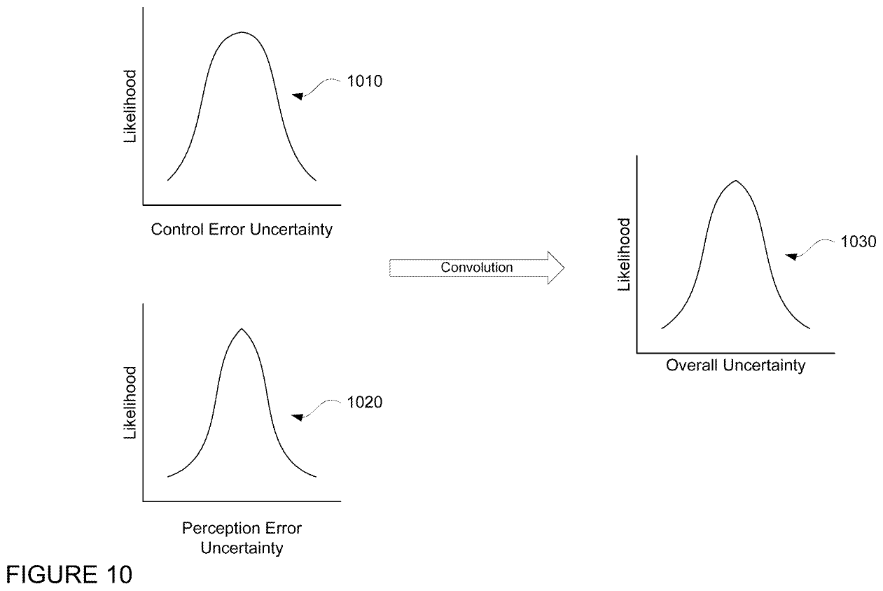

For example, FIG. 10 represents a first distribution 1010 and a second distribution 1020 being convolved into a third distribution 1030. In this example, the first distribution may represent a position control error distribution for the autonomous vehicle 100, the second distribution may represent a perception uncertainty distribution for the bicyclist 650, and the third distribution may represent a first overall uncertainty distribution for the bicyclist. Each of these distributions represents a likelihood for different uncertainties; position control error uncertainty, perception uncertainty, and overall uncertainty. A similar process may be performed for the position control error distribution for the autonomous vehicle 100 and the perception uncertainty distribution for the vehicle 660 in order to determine a first overall uncertainty distribution for the vehicle 660.

The planning system 168 may then access a risk assessment value which indicates how risk-averse the autonomous vehicle should be. For instance, this risk assessment value may be a limit on a number of a certain type of interactions such as collisions or near collisions (i.e. coming within a very small distance of an object) for some amount of driving (e.g. time or miles). In some instances, these risk assessment values may be broken out by the type of object such that different numbers of such interactions with certain types of objects may be considered more acceptable than others. For example, it may be more acceptable to more often come close to another vehicle than to more often come close to a pedestrian. In some instances, these risk assessment values may be further broken out by relative speeds or corresponding severity levels for collisions or other interactions. For example, it may be more acceptable to come close to a pedestrian at 2 miles per hour as compared to coming close to a pedestrian at 75 miles per hour. These values may be set or allocated based on safety and other concerns of an autonomous vehicle service, etc.

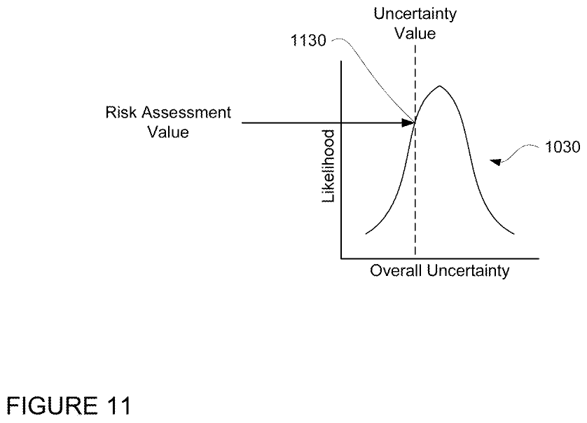

The risk assessment value may then be used to query the first overall uncertainty distribution to find an uncertainty value. FIG. 11 represents the third distribution 1030 and an uncertainty value 1130 selected for the bicyclist 650 based on a risk assessment value for interactions with bicyclists. A similar process may be used to select an uncertainty value for the vehicle 660 using a risk assessment value for interactions with vehicles. These uncertainty values (e.g. the uncertainty value 1130) may then be used to define a buffer around an object which the autonomous vehicle should avoid when planning the first portion of a trajectory. In some instances, the buffer may be determined by adding the uncertainty value to a minimum buffer value. The buffer may then be used as a constraint to limit how close the autonomous vehicle can come to the object and its predicted future locations when planning the first portion of the trajectory. As a result, the likelihood of having a near collision or collision will be smaller than the risk assessment value for the interaction.

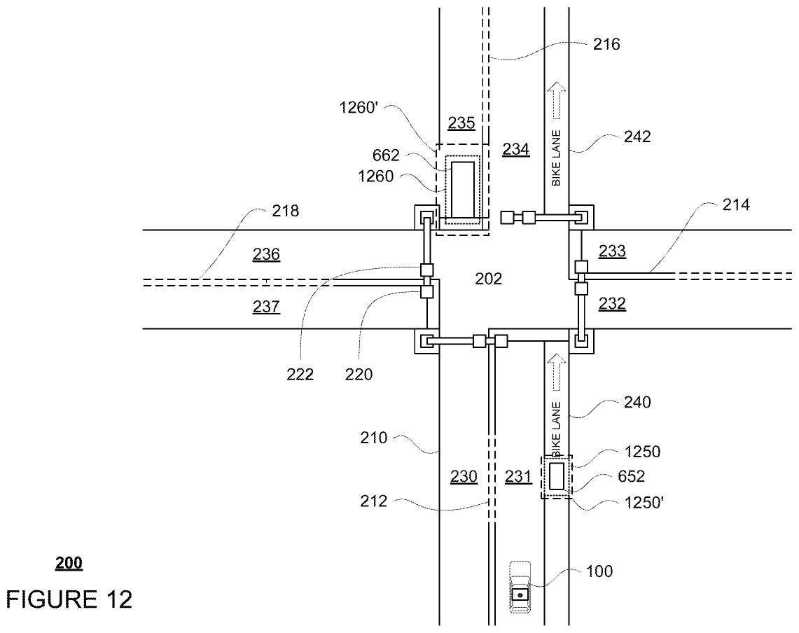

FIG. 12 represents an example of the map information 200 as well as the bounding boxes 652 and 662 representing the bicyclist 650 and vehicle 660, respectively. This example depicts a default buffer 1250 for the bicyclist 650 as well as a default buffer 1260 for the vehicle 660. The uncertainty values selected for the bicyclist and the vehicle 660 may then be used to adjust those buffers. In this regard, the default buffer 1250 is adjusted to buffer 1250′, and the default buffer 1260 is adjusted to buffer 1260′. In this regard, the first overall uncertainty distributions are used to increase the buffers values.

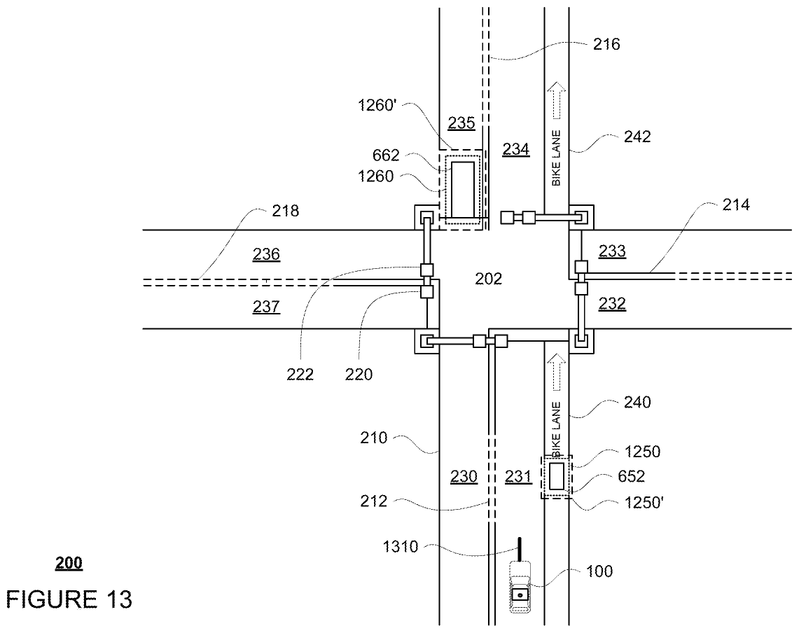

These adjusted buffer values may then be used as constraints for the planning system 168 in order to generate a first portion of a trajectory (or a nominal trajectory) while also avoiding getting too close to or colliding with the bicyclist 650 and vehicle 660. In this regard, FIG. 13 represents a first portion 1310 of a trajectory (e.g. a fallback trajectory) of the autonomous vehicle which may enable the autonomous vehicle to make progress towards a destination of the autonomous vehicle (e.g. while following route 670). The length of the first portion 1310 is exaggerated for ease of understanding.

Returning to FIG. 1830, a fallback portion of the trajectory is generated using a second uncertainty distribution for the object. The fallback portion enables the autonomous vehicle to stop. The second uncertainty distribution is different from the first uncertainty distribution, and the second uncertainty distribution is based on a predetermined uncertainty distribution if the autonomous vehicle loses a localization improvement process. To further reduce the likelihood of situations like coming too close or colliding with another road user object when following a fallback portion of a trajectory, additional uncertainties may be taken into account. For instance, the fallback portion of the trajectory may be planned to take into account uncertainty caused by a loss of functionality into localization improvement processes. In this regard, the planning system may generate the fallback portion of a trajectory according to this “worst-case-scenario”. In this regard, a third uncertainty distribution, which characterizes the different likelihoods of potential position error in the event that the localization improvement processes are lost, may be used. Accounting for uncertainty caused by a loss of functionality into localization during the first portion of the trajectory as well as the fallback portion may cause an autonomous vehicle to drive unnecessarily far from objects when the localization processes are available. Doing so may even cause the autonomous vehicle to get stuck trying to navigate narrow passages that can otherwise be navigated safely when localization improvement processes are available or functioning normally.

This third distribution may be generated offline, for instance, by the server computing devices 410. For instance, while testing on a closed course for safety, the localization improvement processes may be turned off and error values may be measured and observed to determine how quickly the error accumulates. This data may then be used to build a distribution. Alternatively, the logs of localization corrections generated by the localization improvement processes may be used to build a model assuming this correction was not made.

Thus, during planning of the fallback portion, the planning system may not only select first and second distributions for each object as described above, but these may be convolved with the third uncertainty distribution. This may again involve a typical convolution process as described above with or without the aforementioned assumption to simplify computations. The resulting second overall uncertainty distribution may therefore represent the likelihood of the autonomous vehicle coming closer to that object than expected or intended if there is a total loss of functionality into the localization improvement processes.

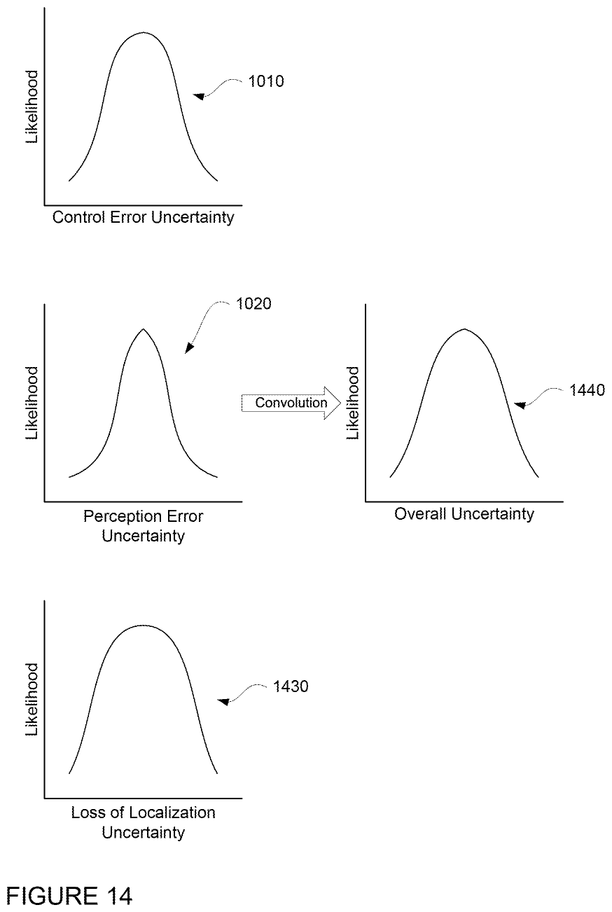

For example, FIG. 14 represents the first distribution 1010, the second distribution 1020, and a third distribution 1430 being convolved into a fourth distribution 1440. In this example, the first distribution may represent a position control error distribution for autonomous vehicle 100, the second distribution may represent a perception uncertainty distribution for the bicyclist 650, the third distribution may represent a loss of functionality into localization distribution which characterizes the different likelihoods of potential position error in the event that the functionality of the localization improvement processes are lost, and the fourth distribution may represent a second overall uncertainty distribution for the bicyclist. Each of these distributions represents a likelihood for different uncertainties; position control error uncertainty, perception uncertainty, loss of functionality into the localization improvement processes (here, loss of localization uncertainty), and overall uncertainty. A similar process may be performed for the position control error distribution for the autonomous vehicle 100, the perception uncertainty distribution for the vehicle 660, and a third distribution (which may be the same as the third distribution 1430) which characterizes the different likelihoods of potential position error in the event that the localization improvement processes are lost in order to determine a second overall uncertainty distribution for the vehicle 660.

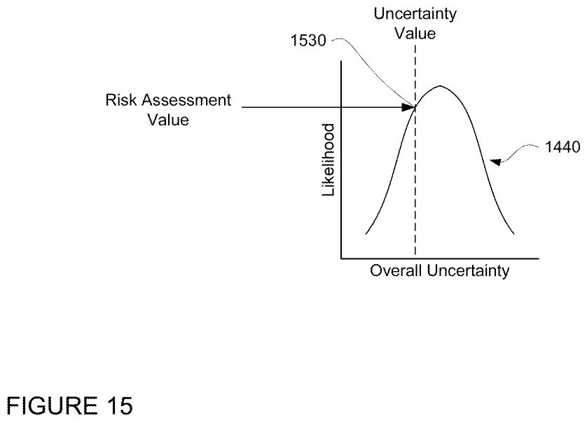

As with the planning of the first portion of the trajectory, the same or a different risk assessment value (e.g. one specifically designated for fallback situations) may then be used to query the second overall uncertainty distribution to find a value or range of values. FIG. 15 represents the third distribution 1030 and an uncertainty value 1530 selected for the bicyclist 650 based on a risk assessment value (e.g. a probability) for interactions with bicyclists. A similar process may be used to select a value for the vehicle 660 using a risk assessment value for interactions with vehicles.

These uncertainty values (e.g. the uncertainty value 1530) may then be used to define a buffer around an object which the autonomous vehicle should avoid when planning the fallback portion of the trajectory. In some instances, the buffer may be determined by adding the uncertainty value to a minimum buffer value. The buffer may then be used as a constraint to limit how close the autonomous vehicle can come to the object and its predicted future locations when planning the fallback portion of the trajectory. As a result, the likelihood of having a near collision or collision will be smaller than the risk assessment value for the interaction. For instance, because localization error will accumulate with time and distance traveled, the buffer distances for objects that are farther away from the autonomous vehicle will be greater than the buffer distances for objects (of the same time) that are closer to the vehicle.

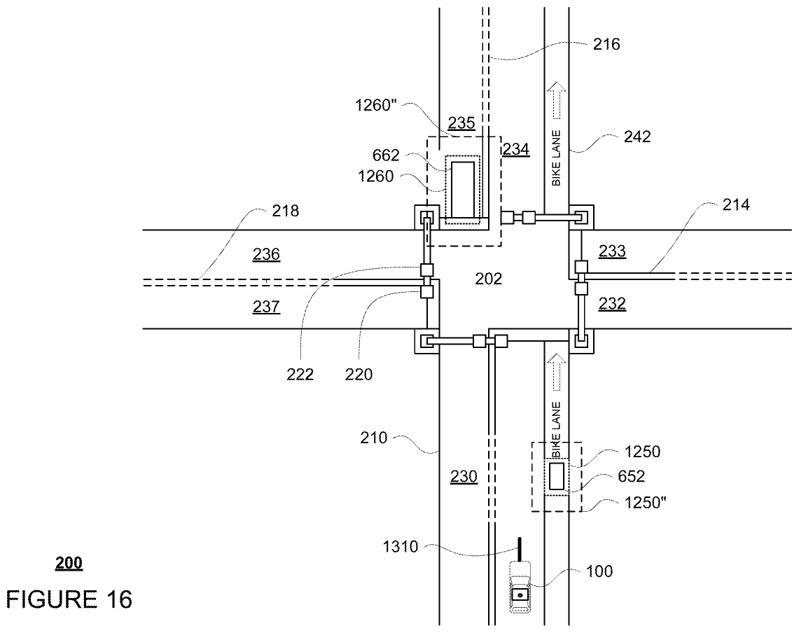

FIG. 16 represents an example of the map information 200 as well as the bounding boxes 652 and 662 representing the bicyclist 650 and vehicle 660, respectively. This example depicts a default buffer 1250 for the bicyclist 650 as well as a default buffer 1260 for the vehicle 660. The uncertainty values selected for the bicyclist and the vehicle 660 may then be used to adjust those buffers. In this regard, the default buffer 1250 is adjusted to buffer 1250″, and the default buffer 1260 is adjusted to buffer 1260″. In this regard, the second overall uncertainty distributions are used to increase the buffers values, even greater than the first overall uncertainty distributions. In other words, the area of the buffer 1250″ is greater than the area of the buffer 1250′, and the area of the buffer 1260″ is greater than the area of the buffer 1260′.

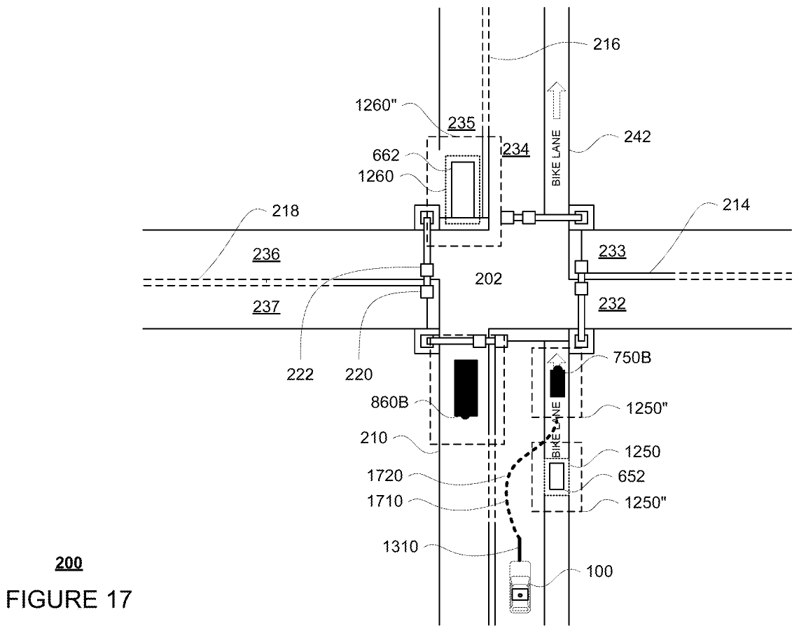

These adjusted buffer values may then be used as constraints for the planning system 168 in order to generate a first portion of a trajectory (or a nominal trajectory) while also avoiding getting too close to or colliding with the bicyclist 650 and vehicle 660. In this regard, FIG. 17 represents a trajectory 1710 including first portion 1310 which may enable the autonomous vehicle to make progress towards a destination of the autonomous vehicle (e.g. while following route 670) and a second or fallback portion 1720.

Returning to FIG. 1840, the autonomous vehicle may be controlled according to the trajectory. In this regard, the planning system 168 may publish the trajectory to the computing devices 110 which may use the trajectory 1710 to control the autonomous vehicle 100 as described above. As described above, under normal operation, because the trajectory used by the computing devices 110 is updated before the autonomous vehicle reaches the fallback portion 1720 (e.g. the 400 milliseconds section where the fallback trajectory diverges from the nominal trajectory), the autonomous vehicle 100 only follows the nominal trajectory.

However, if a new trajectory is not published by the time the fallback portion is reached or some point before this, the computing devices 110 may simply continue to follow the fallback portion of the fallback trajectory and bring the autonomous vehicle to a stop. In this regard, as shown in FIG. 17, the autonomous vehicle may continue to follow the fallback portion 1720 swerving towards lane 231 and thereafter pulling into the bicycle lane 240 and coming to a stop. This trajectory 1710 may include a speed component such that by the time the vehicle 660 reaches the location 860B, the autonomous vehicle is able to avoid the area of buffer 1260″ (as the vehicle progresses along its trajectory), and by the time the bicyclist 650 reaches the location 750B, the autonomous vehicle is able to come to a stop behind the bicyclist and avoid the area of buffer 1250″ (as the bicyclist progresses along its trajectory).

In some instances, the aforementioned distributions may be further combined (convolved with or without the aforementioned assumption) with models or distributions of uncertainty from other sources to produce an even more comprehensive position error distribution. Such other sources may include, for example, actuation uncertainty from steering or speed actuators (such as those which control acceleration and/or deceleration), environmental conditions (such as wet, snowy, or icy roads), etc. For instance, when planning the first portion and/or fallback portion of a trajectory, for dynamic objects, a behavior prediction uncertainty distribution model may also be used. This behavior prediction uncertainty distribution may be generated by the behavior modeling system. This may be convoluted with the first and second distributions, but may be unnecessary for stationary objects. In this regard, the planning of a trajectory need not only take into account three uncertainty distributions, but may use as many as necessary for the given situation or object.

Depending on the computing and other resources available, the aforementioned features may be implemented in different ways. For an autonomous vehicle in which multiple trajectories can be planned for a given planning iteration, the planning system may generate two or more different fallback portions for the same trajectory using different position degradation distributions. For instance, in addition to generating a first fallback portion according to a “worst-case-scenario” with a total loss of the functionality of the localization improvement processes, the planning system may also determine a second fallback portion for that same trajectory without using the third uncertainty distribution. Thereafter, the planning system may select between the two trajectories (one with the first fallback portion and the other with the second fallback portion) based on whether or not the autonomous vehicle has lost the ability to use the localization improvement processes.

The features described herein may allow autonomous vehicles to incorporate degradation of localization improvement processes into trajectory planning for autonomous vehicles. Doing so may reduce the likelihood of a collision during the fallback portion of the trajectory by accounting for a new source of error. Without this feature, an autonomous vehicle may drive inappropriately close to an object during the fallback portion. In addition, by doing so, the autonomous vehicle may be able to operate longer under degraded conditions. This, in turn, may make it more likely that the autonomous vehicle will reach a safe stopping position (e.g. out of traffic or away from other dangers) when following a fallback portion of a trajectory. Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method of controlling an autonomous vehicle, the method comprising:
receiving, by one or more processors, data identifying an object;
generating, by one or more processors, a first portion of a trajectory using a first uncertainty distribution for the object, wherein the first portion of the trajectory enables the autonomous vehicle to make progress towards a destination of the autonomous vehicle;
generating, by one or more processors, a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and
controlling, by the one or more processors, the autonomous vehicle according to the trajectory.

2. The method of claim 1, further comprising:
determining the first uncertainty distribution as a convolution of a position control error uncertainty distribution and a position perception error uncertainty distribution; and
determining the second uncertainty distribution as a convolution of the position control error uncertainty distribution, the position perception error uncertainty distribution, and the predetermined uncertainty distribution.

3. The method of claim 1, further comprising, using the second uncertainty distribution to determine a buffer for avoiding the object.

4. The method of claim 3, wherein determining the buffer for the object includes using a risk assessment value to identify a value from the second uncertainty distribution.

5. The method of claim 4, wherein the risk assessment value indicates how risk-averse the autonomous vehicle should be.

6. The method of claim 1, further comprising:
planning, by the one or more processors, a second trajectory without using the predetermined uncertainty distribution; and
selecting, by the one or more processors, the trajectory from the trajectory and the second trajectory based on a determination of whether the autonomous vehicle is able to use the localization improvement process, and wherein the controlling is in response to the selecting.

7. The method of claim 1, wherein generating the first portion includes using a first risk assessment value and generating the fallback portion includes using a second risk assessment value, the first risk assessment value being different from the second risk assessment value.

8. A system for controlling an autonomous vehicle, the system comprising:
one or more processors configured to:
receive data identifying an object;
generate a first portion of a trajectory using a first uncertainty distribution for the object, wherein the first portion of the trajectory enables the autonomous vehicle to make progress towards a destination of the autonomous vehicle;
generate a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and
control the autonomous vehicle according to the trajectory.

9. The system of claim 8, wherein the one or more processors are further configured to:
determine the first uncertainty distribution as a convolution of a position control error uncertainty distribution and a position perception error uncertainty distribution; and
determine the second uncertainty distribution as a convolution of the position control error uncertainty distribution, the position perception error uncertainty distribution, and the predetermined uncertainty distribution.

10. The system of claim 8, wherein the one or more processors are further configured to use the second uncertainty distribution to determine a buffer for avoiding the object.

11. The system of claim 10, wherein the one or more processors are further configured to determine the buffer for the object by using a risk assessment value to identify a value from the second uncertainty distribution.

12. The system of claim 11, wherein the risk assessment value indicates how risk-averse the autonomous vehicle should be.

13. The system of claim 8, wherein the one or more processors are further configured to:
plan a second trajectory without using the predetermined uncertainty distribution; and
select the trajectory from the trajectory and the second trajectory based on a determination of whether the autonomous vehicle is able to use the localization improvement process, and wherein the controlling is in response to the selecting.

14. The system of claim 8, wherein the one or more processors are further configured to generate the first portion by using a first risk assessment value and generating the fallback portion includes using a second risk assessment value, the first risk assessment value being different from the second risk assessment value.

15. The system of claim 8, further comprising the autonomous vehicle.

16. A non-transitory recording medium on which instructions are stored, the instructions, when executed by one or more processors, cause the one or more processors to perform method of controlling an autonomous vehicle, the method comprising:
receiving data identifying an object;
generating a first portion of a trajectory using a first uncertainty distribution for the object, wherein the first portion of the trajectory enables the autonomous vehicle to make progress towards a destination of the autonomous vehicle;
generating a fallback portion of the trajectory using a second uncertainty distribution for the object, wherein the fallback portion enables the autonomous vehicle to stop, wherein the second uncertainty distribution is different from the first uncertainty distribution and the second uncertainty distribution is based on a predetermined uncertainty distribution if the autonomous vehicle loses a localization improvement process; and
controlling the autonomous vehicle according to the trajectory.

17. The medium of claim 16, wherein the method further comprises:
determining the first uncertainty distribution as a convolution of a position control error uncertainty distribution and a position perception error uncertainty distribution; and
determining the second uncertainty distribution as a convolution of the position control error uncertainty distribution, the position perception error uncertainty distribution, and the predetermined uncertainty distribution.

18. The medium of claim 16, wherein the method further comprises using the second uncertainty distribution to determine a buffer for avoiding the object.

19. The medium of claim 18, wherein the method includes determining the buffer for the object further by using a risk assessment value to identify a value from the second uncertainty distribution.

20. The medium of claim 16, wherein the method further comprises:
planning a second trajectory without using the predetermined uncertainty distribution; and
selecting the trajectory from the trajectory and the second trajectory based on a determination of whether the autonomous vehicle is able to use the localization improvement process, and wherein the controlling is in response to the selecting.
